(19) United States
(12) Patent Application Publication
(10) Pub. No.: US 2025/0029220 A1
(43) Pub. Date: Jan. 23, 2025

(54) ELECTRONIC DEVICE AND CONTROL METHOD OF ELECTRONIC DEVICE

(71) Applicant: CANON KABUSHIKI KAISHA, Tokyo (JP)

(72) Inventor: RYOTA SHOJI, Kanagawa (JP)

(21) Appl. No.: 18/765,868

(22) Filed: Jul. 8, 2024

(30) Foreign Application Priority Data
Jul. 21, 2023 (JP) 2023-119045

(51) Int. Cl. G06T 5/80; H04N 23/61; H04N 23/667

(52) U.S. Cl. CPC G06T 5/80; H04N 23/61; H04N 23/667

(57) ABSTRACT

An electronic device acquires a first image, and a second image that is an image obtained by applying a geometric transformation to the first image to reduce distortion. The electronic device switches display modes between a first mode of displaying an area of the first image in a display region, and a second mode of displaying an area of the second image in the display region. When switching the display modes, the electronic device adjusts a display position of an image that is displayed in the display region after the switching of the display modes such that an object located in a first position in the display region before the switching of the display modes will be located in the first position after the switching of the display modes.

### BACKGROUND OF THE INVENTION

### Field of the Invention

The present invention relates to an electronic device and a control method of the electronic device.

### Description of the Related Art

Two moving images with parallax can be obtained simultaneously using a fisheye lens that has two optical systems in one lens mount. Techniques for displaying such images as a stereoscopic image (VR video) to offer users a three-dimensional VR viewing experience are known.

Japanese Patent Application Publication No. 2017-58801 describes a device that cuts out an image of a predetermined region from a fisheye image, corrects distortions in the image of the cut-out region, and displays the corrected image. In this process, the device allows the user to readily see which region of the fisheye image was cut out.

Sometimes, the user may want to switch between the image of a portion of the fisheye image, and the image of a portion of the corrected image after the distortions in the fisheye image have been corrected. In this case, an object at certain coordinates in one image may differ from an object at the same coordinates in the other image.

When the user switches from viewing one image to another, this sometimes elicited a strange feeling for the user.

### SUMMARY OF THE INVENTION

Accordingly, an object of the present invention is to reduce this strange feeling the user feels when switching from viewing a portion of an image to the portion of the image after distortions in that image are corrected.

An aspect of the present invention is an electronic device including: a processor; and a memory storing a program which, when executed by the processor, causes the electronic device to perform an acquisition process of acquiring a first image, and a second image that is an image obtained by applying a geometric transformation to the first image to reduce distortion, to perform a switching process of switching display modes between a first mode of displaying an area of the first image in a display region, and a second mode of displaying an area of the second image in the display region, and, in a case where the display modes are switched, to perform an adjustment process of adjusting a display position of an image that is displayed in the display region after the switching of the display modes such that an object located in a first position in the display region before the switching of the display modes will be located in the first position after the switching of the display modes.

An aspect of the present invention is a method of controlling an electronic device, including: an acquisition step of acquiring a first image, and a second image that is an image obtained by applying a geometric transformation to the first image to reduce distortion; a switching step of switching display modes between a first mode of displaying an area of the first image in a display region, and a second mode of displaying an area of the second image in the display region; and, in a case where the display modes are switched, an adjustment step of adjusting a display position of an image that is displayed in the display region after the switching of the display modes such that an object located in a first position in the display region before the switching of the display modes will be located in the first position after the switching of the display modes.

Further features of the present invention will become apparent from the following description of exemplary embodiments with reference to the attached drawings.

### BRIEF DESCRIPTION OF THE DRAWINGS

FIG. 1A and FIG. 1B are external views of a camera according to Embodiment 1;

FIG. 2 is a configuration diagram of the camera according to Embodiment 1;

FIG. 3 is a configuration diagram of a lens unit according to Embodiment 1;

FIG. 4 is a configuration diagram of a PC according to Embodiment 1;

FIG. 5A and FIG. 5B are diagrams explaining how images are fitted to the display according to Embodiment 1;

FIG. 6A and FIG. 6B are diagrams explaining how images are partially displayed according to Embodiment 1;

FIG. 7 is a flowchart showing the operation of the PC according to Embodiment 1;

FIG. 8 is a diagram explaining how display positions are adjusted according to Embodiment 1;

FIG. 9A and FIG. 9B are diagrams explaining how circular fisheye images are displayed according to Embodiment 2;

FIG. 10 is a flowchart showing the operation of the PC according to Embodiment 2; and

FIG. 11A and FIG. 11B are diagrams explaining how display positions are adjusted according to Embodiment 2.

### DESCRIPTION OF THE EMBODIMENTS

Embodiments according to the present invention will be hereinafter described in detail with reference to the drawings.

An application for handling stereoscopic images (VR videos) has some display modes such as, for example, a “circular fisheye mode” that displays a captured circular fisheye image, and an “equirectangular projection mode” that displays an image transformed from the circular fisheye image by correcting distortions based on equirectangular projection. Such application typically allows toggling between a “fit-to-screen mode” that reduces the target image so that it entirely fits in a preview area, and a “zoom-in mode” that displays a portion of the image. The zoom-in mode includes a dot-by-dot display.

Let us assume that a user is checking an object in an image in the circular fisheye mode as well as in the zoom-in mode, and wishes to switch the display mode from the circular fisheye mode to the equirectangular projection mode, while keeping the zoom-in mode. Sometimes, the object the user was checking in a center position of the image display region before switching the display mode is not displayed in the same position after the display mode was switched. In particular, an object near the circumference in the circular fisheye image tends to shift largely when the display modes are switched, and such changes in position of the object every time the display modes are switched was sometimes a nuisance.

### Embodiment 1

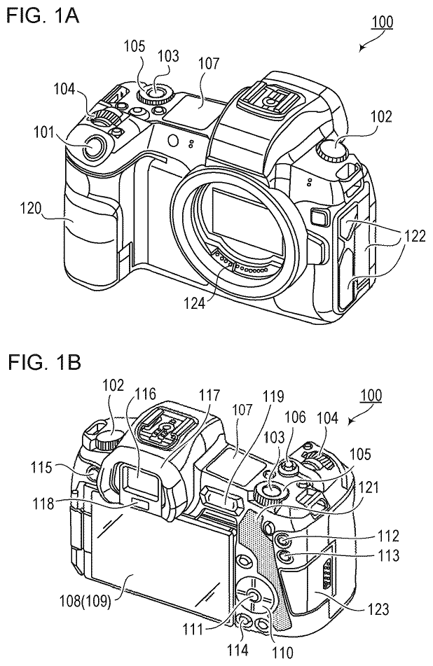

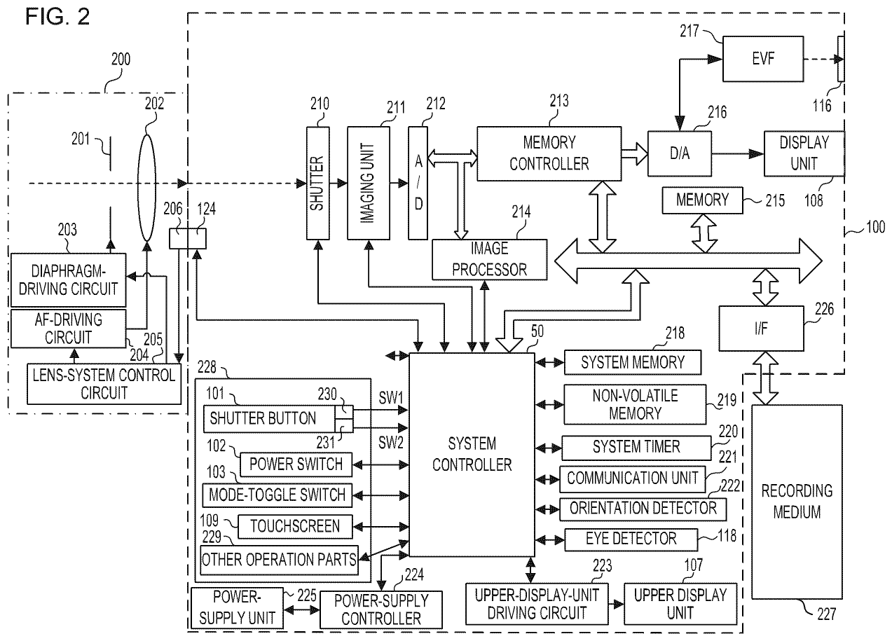

An imaging device according to Embodiment 1 is a digital camera that captures a moving image with a dual lens (VR180 lens). The digital camera (hereinafter, camera) 100 that captures images will be described below. FIG. 1A and FIG. 1B are external views of the camera 100 according to Embodiment 1. FIG. 1A is a perspective view of the camera 100 viewed from the front. FIG. 1B is a perspective view of the camera 100 viewed from the rear. FIG. 2 is a diagram illustrating one configuration example of the camera 100.

The camera 100 includes a shutter button 101, a power switch 102, a mode-toggle switch 103, a main electronic dial 104, a sub electronic dial 105, a video button 106, and an upper display unit 107 on an upper surface. The shutter button 101 is an operation part that allows preparation for shooting to be made or a shooting command to be input. The power switch 102 is an operation part for switching between power on and power off of the camera 100. The mode-toggle switch 103 is an operation part for toggling various modes. The main electronic dial 104 is a rotary operation part for changing the settings such as shutter speed or aperture. The sub electronic dial 105 is a rotary operation part for moving a selection frame (cursor) or fast-forwarding images. The video button 106 is an operation part for inputting an instruction to start or stop shooting (recording) of a moving image. The upper display unit 107 displays various settings such as shutter speed or aperture.

The camera 100 includes a display unit 108, a touchscreen 109, a direction key 110, SET button 111, an AE lock button 112, a zoom button 113, a playback button 114, a menu button 115, an eyepiece 116, an eye detector 118, and a touch bar 119 on the backside.

The display unit 108 displays images and various pieces of information. The touchscreen 109 is an operation part that detects touch gestures on a display surface (touch operation surface) of the display unit 108. The direction key 110 is an operation part composed of keys (four direction keys) that can be pressed in at upper, lower, left, and right portions. The direction key 110 can accept inputs corresponding to the pressed down positions of the direction key 110. The SET button 111 is an operation part that is pressed down mainly for determining selection of an item. The AE lock button 112 is an operation part that is pressed down for locking exposure settings in a state ready for shooting.

The zoom button 113 is an operation part for toggling ON and OFF of the zoom mode in a live view display (LV display) of a shooting mode. When the zoom mode is ON, the live view image (LV image) can be enlarged or reduced by operating the main electronic dial 104. The zoom button 113 is also used for enlarging an image being played back in a playback mode, or for increasing the enlargement ratio (display magnification). The playback button 114 is an operation part for switching between the shooting mode and the playback mode. When the playback button 114 is pressed down during the shooting mode, the mode switches to the playback mode, allowing the user to see the newest one of the images recorded in a recording medium 227 to be described later in the display unit 108.

The menu button 115 is an operation part that is pressed down for displaying a menu screen that allows various settings to be configured in the display unit 108. The menu button 115 displayed in the display unit 108 allows the user to configure various settings intuitively using the direction key 110 and SET button 111. The eyepiece 116 is a part for the user to position one eye relative to an eyepiece viewfinder 117 (to look into the viewfinder). The user can see the images displayed in an internal EVF (Electronic View Finder) 217 to be described later through the eyepiece 116. The eye detector 118 is a sensor that detects whether or not a user's eye is in contact with the eyepiece 116.

The touch bar 119 is a touch operation part (linear touch sensor) that can accept touch operations. The touch bar 119 is placed in a position where the user can touch-operate (touch) it with the right thumb while gripping a grip portion 120 (with the middle, ring, and little fingers of the right hand) so as to be able to press down the shutter button 101 with the right index finger. Namely, the user can operate the touch bar 119 in a state ready to press down the shutter button 101 any time, with one eye placed on the eyepiece 116 and looking into the eyepiece viewfinder 117 (shooting posture). The touch bar 119 can accept a tap gesture on the touch bar 119 (touching the bar and removing the finger without moving within a preset time), or a slide gesture to the left and right (touching and moving the finger on the bar). The touch bar 119 is an operation part different from the touchscreen 109 and does not have a display function. The touch bar 119 in this embodiment is a multifunctional bar, i.e., it functions also as an M-Fn bar, for example.

The camera 100 also includes the grip portion 120, a thumb rest 121, a terminal cover 122, a lid 123, and a communication terminal 124.

The grip portion 120 is a hold part formed in a shape that allows the user to readily grip the camera 100 with the right hand. The shutter button 101 and main electronic dial 104 are located where the user can operate them with the right index finger while holding the camera 100 by gripping the grip portion 120 with the middle, ring, and little fingers of the right hand. The sub electronic dial 105 and touch bar 119 are located where the user can operate them with the right thumb in a similar condition. The thumb rest 121 (thumb wait position) is a grip portion provided on the backside of the camera 100 where the user can readily rest the right thumb while gripping the grip portion 120 and not operating any of the operation parts.

The thumb rest 121 is formed by a rubber member or the like for an enhanced hold (for a better grip). The terminal cover 122 protects a connector for a connection cable or the like used for connecting the camera 100 to an external device. The lid 123 is for closing a slot, which is for receiving a recording medium 227 to be described later, to protect the recording medium 227 and the slot. The communication terminal 124 is a terminal that allows communications between the camera 100 and the lens unit 200 that can be mounted to and removed from the camera.

FIG. 2 is a diagram illustrating one internal configuration example of the camera 100. The same constituent parts as those of FIG. 1A and FIG. 1B are given the same reference numerals and description thereof will be omitted as suited. The lens unit 200 is mounted to the camera 100.

The lens unit 200 will be described first. The lens unit 200 is a type of replaceable lens that can be mounted to and removed from the camera 100. The lens unit 200 is a one-eye lens, i.e., an example of a normal lens.

The lens unit 200 includes a diaphragm 201, a lens 202, a diaphragm-driving circuit 203, an AF (auto focus) driving circuit 204, a lens-system control circuit 205, and a communication terminal 206.

The diaphragm 201 can adjust the aperture size. The lens 202 is composed of a plurality of lenses. The diaphragm-driving circuit 203 controls the aperture size of the diaphragm 201 to adjust the amount of light. The AF-driving circuit 204 drives the lens 202 to achieve a focus.

The lens-system control circuit 205 controls the diaphragm-driving circuit 203, AF-driving circuit 204 and others based on instructions given by a system controller 50 to be described later. The lens-system control circuit 205 controls the diaphragm 201 via the diaphragm-driving circuit 203, and shifts the position of the lens 202 via the AF-driving circuit 204 to achieve a focus. The lens-system control circuit 205 can communicate with the camera 100. Specifically, the camera 100 and the lens unit 200 communicate with each other via the communication terminal 206 of the lens unit 200 and the communication terminal 124 of the camera 100. The communication terminal 206 is a terminal that allows the lens unit 200 to communicate with the camera 100.

Next, the camera 100 will be described. The camera 100 includes a shutter 210, an imaging unit 211, an A/D converter 212, a memory controller 213, an image processor 214, a memory 215, a D/A converter 216, an EVF 217, the display unit 108, and the system controller 50.

The shutter 210 is a focal-plane shutter that is able to freely control the exposure time of the imaging unit 211 based on an instruction given by the system controller 50.

The imaging unit 211 is an imager (image sensor) composed of a CCD or CMOS device that converts an optical image into an electrical signal. The imaging unit 211 may include an imaging plane phase difference sensor that outputs information on an amount of defocus to the system controller 50.

The A/D converter 212 converts an analog signal output from the imaging unit 211 into a digital signal.

The image processor 214 performs predetermined processing (resizing such as pixel interpolation or size reduction, or color conversion) to the data from the A/D converter 212, or the data from the memory controller 213. The image processor 214 also performs predetermined computations using the data of the captured images. The system controller 50 controls exposure and metering based on the obtained computation results. This is followed by AF (auto focus) processing, AE (auto exposure) processing, EF (pre-flashing) processing and so on in TTL (through the lens) mode. The image processor 214 further performs predetermined computations using the data of captured images, and performs AWB (auto white balance) processing in TTL mode based on the obtained computation results.

The image data from the A/D converter 212 is written in the memory 215 via the image processor 214 and memory controller 213. Alternatively, the image data from the A/D converter 212 is written in the memory 215 via the memory controller 213 and not via the image processor 214. The memory 215 stores image data obtained by the imaging unit 211 and converted to digital data by the A/D converter 212, and image data to be displayed in the display unit 108 or EVF 217. The memory 215 is equipped with a sufficient storage capacity to store a predetermined number of still images and a predetermined length of video and audio. The memory 215 also doubles as a memory for image display (video memory).

The D/A converter 216 converts the data stored in the memory 215 for image display into an analog signal and supplies the signal to the display unit 108 or EVF 217. Thus the image data written in the memory 215 is output to the display unit 108 or EVF 217 via the D/A converter 216 for display. The image is displayed in the display unit 108 and EVF 217 in accordance with the analog signal from the D/A converter 216. The display unit 108 and EVF 217 are displays such as an LCD or organic EL, for example. A digital signal converted by the A/D converter 212 and accumulated in the memory 215 is converted into an analog signal by the D/A converter 216. The analog signal is consecutively transmitted to the display unit 108 or EVF 217 so that an image is displayed on the basis of the analog signal. The live view display is thus realized.

The system controller 50 is a control unit having at least one processor and/or at least one circuit. That is, the system controller 50 may be a processor, or a circuit, or a combination of a processor and a circuit. The system controller 50 controls the overall operation of the camera 100. The system controller 50 executes a program recorded in a non-volatile memory 219 to implement each step of processing in the flowchart to be described later. The system controller 50 also controls the memory 215, D/A converter 216, display unit 108, and EVF 217 to control the display.

The camera 100 further includes a system memory 218, the non-volatile memory 219, a system timer 220, a communication unit 221, an orientation detector 222, and the eye detector 118.

A RAM, for example, is used as the system memory 218. The system memory 218 is used for deploying the constants and variables for the operation of the system controller 50, and programs read out from the non-volatile memory 219.

The non-volatile memory 219 is an electrically erasable and writable memory. An EEPROM, for example, is used as the non-volatile memory 219. The non-volatile memory 219 records constants, programs and the like for the operation of the system controller 50.

The system timer 220 is a time counter that counts time for various control operations or the time of a built-in clock.

The communication unit 221 sends and receives video signals or audio signals to and from external equipment connected thereto wirelessly or via a wire cable. The communication unit 221 can also connect to a wireless LAN (Local Area Network) or the Internet. The communication unit 221 can also communicate with external equipment via Bluetooth (trademark) or Bluetooth Low Energy. The communication unit 221 can send out images captured by the imaging unit 211 (including live images) or images recorded in the recording medium 227. The communication unit 221 can receive image data or various pieces of information from external equipment.

The orientation detector 222 detects the orientation of the camera 100 relative to the direction of gravity. Whether an image captured by the imaging unit 211 is an image taken with the camera 100 set horizontally or vertically can be determined on the basis of the orientation detected by the orientation detector 222. The system controller 50 is able to add the information on the orientation detected by the orientation detector 222 to the image file of the image captured by the imaging unit 211. The system controller 50 can record the image after rotating the image in accordance with the orientation information. An acceleration sensor or a gyro sensor, for example, may be used as the orientation detector 222. It is also possible to detect a movement of the camera 100 (pan, tilt, pick-up, stationary or not, etc.) using the orientation detector 222.

The eye detector 118 can detect an object approaching the eyepiece 116 of the eyepiece viewfinder 117 that has the EVF 217 therein. An infrared proximity sensor, for example, may be used as the eye detector 118. An approaching object reflects the infrared projected from a light transmitter in the eye detector 118, and the reflected light is received by a light receiver of the infrared proximity sensor. The eye detector 118 can determine the distance from the eyepiece 116 to the object based on the amount of received infrared. The eye detector 118 thus senses the distance from an object in the proximity of the eyepiece 116 to detect an approaching eye.

The eye detector 118 is an eye sensor that detects an eye (object) coming closer (proximity) and moving away (separation) to and from the eyepiece 116 of the eyepiece viewfinder 117. When an object approaching the eyepiece 116 within a predetermined distance is detected during an object absent state (non-detected state), the sensor determines that an eye has been placed on the viewfinder. On the other hand, when the object that was detected to be in the proximity moves away by a predetermined distance or more during an object present state (detected state), the sensor determines that the eye has been moved away. The threshold for detecting an eye coming closer and the threshold for detecting the eye moving away may be different by the use of a hysteresis, for example. After proximity of an eye has been detected, the eye present state is maintained until separation of the eye is detected. After separation of the eye has been detected, the eye absent state is maintained until eye proximity is detected.

The system controller 50 toggles the display (state)/non-display (state) of the display unit 108 and the EVF 217 in accordance with the state detected by the eye detector 118. Specifically, when the camera is in the state ready for shooting and the setting for switching display destinations is set to automatic switching, the display unit 108 is selected as the display destination during the eye absent state (the display unit 108 is turned on to display images there), while the EVF 217 is turned off. During the eye present state, the system controller 50 selects the EVF 217 as the display destination (turns on the EVF 217 to display images there), while turning off the display unit 108. The eye detector 118 is not limited to an infrared proximity sensor, and can be any other sensors that can detect a state indicating proximity of an eye.

The camera 100 further includes the upper display unit 107, an upper-display-unit driving circuit 223, a power-supply controller 224, a power-supply unit 225, a recording medium I/F 226, an operation unit 228, and a video signal output I/F 240.

The upper display unit 107 displays various settings of the camera 100 such as shutter speed or aperture via the upper-display-unit driving circuit 223.

The power-supply controller 224 is composed of a battery-detection circuit, a DC-DC converter, a switch circuit that switches the blocks to be powered, and so on. The power-supply controller 224 detects whether or not a battery is mounted, and determines the type of battery and remaining battery charge. The power-supply controller 224 controls the DC-DC converter based on its detection results and instructions from the system controller 50. The power-supply controller 224 supplies a necessary voltage to various units including the recording medium 227 for a necessary period of time.

The power-supply unit 225 may include primary batteries (alkaline or lithium batteries), secondary batteries (NiCd, NiMH, or Li batteries), an AC adapter, and so on.

The recording medium I/F 226 is an interface for connecting the recording medium 227 (such as a memory card, hard disk, and so on). The recording medium 227 is a memory card for recording captured images. The recording medium 227 is composed of a semiconductor memory or a magnetic disc. The recording medium 227 may be removably mounted to the camera 100, or may be built in the camera 100.

The operation unit 228 is an input unit for accepting operations performed by the user (user operations). The operation unit 228 is used for inputting various instructions to the system controller 50.

The operation unit 228 includes the shutter button 101, power switch 102, mode-toggle switch 103, touchscreen 109, and other operation parts 229. Other operation parts 229 include the main electronic dial 104, sub electronic dial 105, video button 106, direction key 110, SET button 111, AE lock button 112, zoom button 113, playback button 114, menu button 115, and touch bar 119.

The shutter button 101 includes a first shutter switch 230 and a second shutter switch 231. The first shutter switch 230 turns on in the middle of operation of the shutter button 101 (half-press) and generates a first shutter switch signal SW1 (instruction to be ready for shooting). Upon generation of the first shutter switch signal SW1, the system controller 50 starts processing to be ready for shooting such as AF processing, AE processing, AWB processing, EF processing and so on. The second shutter switch 231 turns on at the end of operation of the shutter button 101 (full-press) and generates a second shutter switch signal SW2 (shooting instruction). Upon generation of the second shutter switch signal SW2, the system controller 50 starts a series of shooting processes (reading out signals from the imaging unit 211, generating an image file including captured images, and writing the image file in the recording medium 227).

The mode-toggle switch 103 is for switching the operation mode of the system controller 50 to one of a still-image shooting mode, a video-shooting mode, a playback mode, and so on. The still-image shooting mode may further include an auto-imaging mode, automatic scene-recognition mode, manual mode, aperture-priority mode (Av mode), shutter-speed priority mode (Tv mode), and program AE mode (P mode). The still-image shooting mode further includes various scene modes, custom mode, etc., that allow setting for individual scenes. The mode-toggle switch 103 allows the user to directly switch to one of these shooting modes. Alternatively, the user may first switch to a screen showing a list of shooting modes using the mode-toggle switch 103, and then select one of the plurality of displayed modes using the operation unit 228 to switch to that mode. Similarly, the video-shooting mode may further include a plurality of modes.

The touchscreen 109 is a touch sensor that detects various touch gestures on the display surface of the display unit 108 (operation surface of the touchscreen 109). The touchscreen 109 and display unit 108 may be configured integrally. For example, the touchscreen 109 may be installed in an upper layer of the display surface of the display unit 108 so that the light transmission rate does not obstruct the screen view of the display unit 108. The input coordinates in the touchscreen 109 are matched with the display coordinates on the display surface of the display unit 108 to implement a GUI (graphical user interface), which allows the user to feel as if the screen displayed in the display unit 108 is directly operable.

The touchscreen 109 may be any of various types of touchscreens such as resistive touchscreens, capacitive touchscreens, surface acoustic wave touchscreens, infrared touchscreens, electromagnetic induction touchscreens, image recognition touchscreens, optical imaging touchscreens, and so on. Some types of touchscreens detect contact with the touchscreen 109 as a touch while others detect proximity of a finger or pen to the touchscreen 109 as a touch. Either type may be used.

The system controller 50 is able to detect the following operations made to the touchscreen 109 or the states of the touchscreen.
A finger or pen that was not touching the touchscreen 109 newly touching the touchscreen 109, i.e., the start of a touch (hereinafter referred to as “Touch-Down”)
A finger or pen touching the touchscreen 109 (hereinafter referred to as “Touch-On”)
A finger or pen touching and moving on the touchscreen 109 (hereinafter referred to as “Touch-Move”)
A finger or pen that was touching the touchscreen 109 being removed (released) from the touchscreen 109, i.e., the end of a touch (hereinafter referred to as “Touch-Up”)
Nothing touching the touchscreen 109 (hereinafter referred to as “Touch-Off”)

Touch-On is detected upon detection of Touch-Down. Normally, Touch-On is continuously detected after Touch-Down unless Touch-Up is detected. Touch-On is also detected simultaneously with the detection of Touch-Move. Touch-Move is not detected even though Touch-On is being detected unless the touched position is moving. Touch-Off is detected upon detection of Touch-Up of all the fingers or pen that were touching.

These operations or states, and the coordinates of the position where a finger or pen is touching on the touchscreen 109 are sent to the system controller 50 via an internal bus. The system controller 50 determines what operation (touch gesture) was performed on the touchscreen 109 based on the sent information. In the case with Touch-Move, the moving direction of the finger or pen on the touchscreen 109 can be determined from the changes in the vertical and horizontal components in position coordinates on the touchscreen 109. A Touch-Move detected over a predetermined distance or more is determined as a sliding gesture.

Moving a finger in contact with the touchscreen 109 only some distance and then releasing it is called a flick. A flick in other words is a quick flicking motion on the touchscreen 109. A Touch-Move detected over a predetermined distance or more at a predetermined speed or more followed by a Touch-Up can be determined as a flick gesture (determined as a flick following a sliding gesture). A touch gesture in which a plurality of (e.g., two) points are touched at the same time (multi-touch) and moved together is called pinch-in, and a touch gesture in which the touch points are moved apart is called pinch-out. Pinch-in and pinch-out are collectively called pinch operation (or simply Pinch).

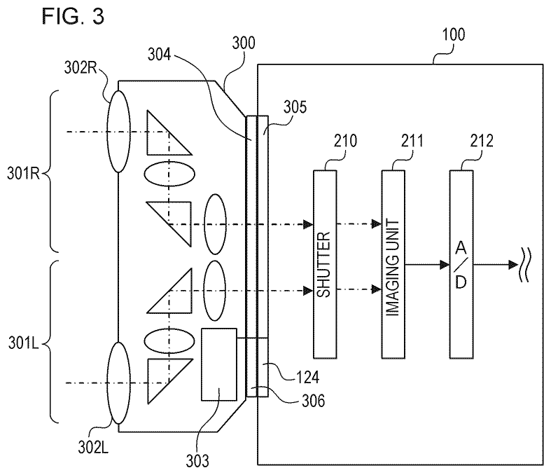

FIG. 3 is a schematic diagram illustrating one configuration example of the lens unit 300. FIG. 3 shows the lens unit 300 mounted to the camera 100. The constituent parts of the camera 100 shown in FIG. 3 that are the same as those described with reference to FIG. 2 are given the same reference numerals and description thereof will be omitted as suited.

The lens unit 300 is a type of replaceable lens that can be mounted to and removed from the camera 100. The lens unit 300 is a dual lens that can capture left and right images with parallax. The lens unit 300 has two optical systems, each having a wide angle of view of about 180° and each adapted to capture an image of a hemispherical range in the front. Specifically, the two optical systems of the lens unit 300 can each capture an image of an object in a field of view (angle of view) of 180° in the left and right direction (horizontal angle, azimuth angle, yaw angle), and 180° in the up and down direction (vertical angle, elevation and depression angles, pitch angle).

The lens unit 300 includes a right-eye optical system 301R having a plurality of lenses, reflection mirrors, etc., a left-eye optical system 301L having a plurality of lenses, reflection mirrors, etc., and a lens-system control circuit 303. The right-eye optical system 301R corresponds to one example of a first optical system, and the left-eye optical system 301L corresponds to one example of a second optical system.

The right-eye optical system 301R and left-eye optical system 301L have respective object-side lenses 302R and 302L oriented in the same direction, i.e., their optical axes are substantially parallel. The lens unit 300 of this embodiment is a VR180 lens adapted to shoot a VR image in the format known as VR180 that allows dual-eye stereoscopic viewing. In a VR180 lens, the right-eye optical system 301R and left-eye optical system 301L each include a fisheye lens capable of capturing an image of about 180° range. The VR180 lens may be a lens adapted to capture a wide angle of view of about 160°, i.e., narrower than 180°, as long as the right-eye optical system 301R and left-eye optical system 301L can each acquire a VR180 video that allows dual-eye VR display. The VR180 lens is able to form a right image formed via the right-eye optical system 301R (first image) and a left image formed via the left-eye optical system 301L (second image) with parallax, on one or two imagers of the camera to which the lens is mounted.

The lens unit 300 is mounted to the camera 100 via a lens mount portion 304 and a camera mount portion 305 of the camera 100. When the lens unit 300 is mounted to the camera 100, the system controller 50 of the camera 100 is electrically connected to the lens-system control circuit 303 of the lens unit 300 via the communication terminal 124 and the communication terminal 306.

In this embodiment, the right image and the left image with parallax, respectively formed via the right-eye optical system 301R and the left-eye optical system 301L, are juxtaposed in the imaging unit 211 of the camera 100. Namely, the two optical images formed by the right-eye optical system 301R and left-eye optical system 301L are formed on one imager. The imaging unit 211 converts the formed image of an object (optical signal) into an analog electrical signal. Thus, using the lens unit 300 allows two images with parallax to be acquired at the same time (as a set), captured from two points by the right-eye optical system 301R and left-eye optical system 301L (optical systems). The VR display of the image thus obtained and split into a left-eye image and a right-eye image allows the user to view a three-dimensional VR image of about 180° range, known as VR180.

The VR images here refer to images that can be displayed in VR as will be described later. The VR images include omnidirectional images (full spherical images) captured with an omnidirectional camera (360° camera), and panoramic images having an image range (effective image range) that is wider than the range of one image that can be displayed in the display unit. The VR images include not only still images but also videos and live images (images acquired from a camera almost in real time). The VR images have an image range (effective image range) covering a maximum of 360° field of view in the left and right direction and the up and down direction. The VR images may not necessarily provide 360° left and right coverage and/or 360° up and down coverage and may include images having a wider angle of view than that of images that can be captured with a normal camera, or images having an image range that is wider than the range of one image that can be displayed in the display unit. The images captured by the camera 100 using the lens unit 300 described above are a type of VR images.

A VR image can be displayed as VR by setting the display mode of a display device (adapted to display VR images) to “VR View”, for example. A VR display of a VR image having an angle of view of 360° allows the user to view an omnidirectional image seamlessly continuous in the left and right direction, as the user changes the orientation of the display device in the left and right direction (horizontal rotating direction).

The VR display (VR view) here refers to a VR image display method (display mode) with a variable display area, whereby an image of the field of view corresponding to the orientation of the display device is displayed. The VR display includes a “single-eye VR display (single-eye VR view)”, which deforms (to correct distortion of) an image by mapping it onto a virtual sphere to display a single VR image. The VR display also includes a “dual-eye VR display (dual-eye VR view)”, which deforms a left-eye image and a right-eye image by mapping each of them onto a virtual sphere to display a left-eye VR image and a right-eye VR image side by side in left and right regions. The “dual-eye VR display” that uses a left-eye VR image and a right-eye VR image taking account of parallax allows for three-dimensional view of these VR images. In either VR display, in the case where the user wears a display device such as an HMD (head-mounted display), for example, the user views images of the field of view corresponding to the direction of the user's face.

For example, let us assume that the VR image being displayed at one point is an image of the field of view with the center at 0° in the left and right direction (specified azimuth such as north) and 90° in the up and down direction (90° from the zenith, i.e., horizontal). From this state, reversing the position of the display device (e.g., changing the orientation so that the display surface faces north instead of south) changes the display area of the VR image to an image of the field of view with the center at 180° in the left and right direction (opposite azimuth, e.g., south) and 90° in the up and down direction. In the case of a user wearing an HMD, this means that when the user turns his/her face from north to south (i.e., turns around), the image displayed in the HMD also changes from that of the north to that of the south. The VR image shot with the use of the lens unit 300 of this embodiment is a VR180 image capturing a substantially 180° range in the front and does not include an image of a substantially 180° range in the back. During a VR display of such a VR180 image, when the orientation of the display device is changed toward the side where no image exists, a blank region is displayed.

Such VR display of VR images gives the user a visual feel as if s/he was there in the VR image (VR space). The method of displaying VR images is not limited to changing the orientation of the display device. For example, the display area may be moved (scrolled) in accordance with user's operations on a touchscreen or direction button. During the VR display (“VR View” display mode), the display area may be changed in accordance with actions such as a touch or move on the touchscreen, a drag of a mouse, or a press on a direction button, in addition to a change in posture. A smartphone mounted on VR goggles (head-mounted adapter) is a type of HMD.

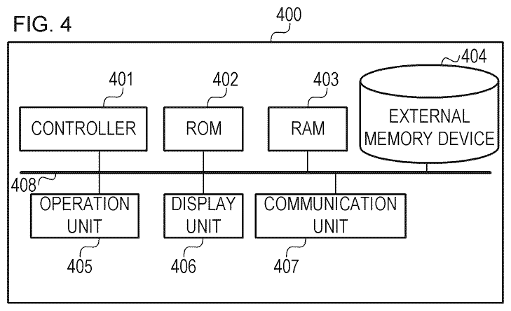

FIG. 4 is a bock diagram illustrating a configuration of a personal computer (PC) 400 that is the electronic device according to Embodiment 1. The PC 400 includes a controller 401, a ROM 402, a RAM 403, an external memory device 404, an operation unit 405, a display unit 406, and a communication unit 407. Other electronic devices such as an imaging device (camera), smartphone, or a tablet terminal may also be used as suited instead of the PC 400.

The controller 401 controls the overall operation of the PC 400. The controller 401 is a central processing unit (CPU), for example. In Embodiment 1, the controller 401 is operable as a display control unit that controls the display in the display unit 406, a switching unit that switches the display modes, and an adjustment unit that adjusts the display positions of images.

The ROM 402 is a read-only memory (ROM) that stores information (programs and parameters) that require no changes. The ROM 402 stores a predetermined information processing program as a program code readable by the controller 401. This program code is executed by the controller 401.

The RAM 403 is a random access memory (RAM) that temporarily stores information (such as programs and data) supplied by an external device.

The external memory device 404 includes a hard disk or a flash memory fixedly installed in the PC 400. The external memory device 404 also includes a memory card that can be mounted to and removed from the PC 400. Images and videos shot by the camera 100 are written as files in the external memory device 404.

The operation unit 405 accepts user operations. The operation unit 405 includes operation members such as a mouse, keyboard, or touchscreen.

The display unit 406 displays contents based on the data retained in the PC 400 or supplied to the PC 400. The display unit 406 may be connected to an external display device and display the contents based on the data in the external display device.

The communication unit 407 is connected to the camera 100 or an external network.

Various parts of the PC 400 are interconnected via a system bus 408.

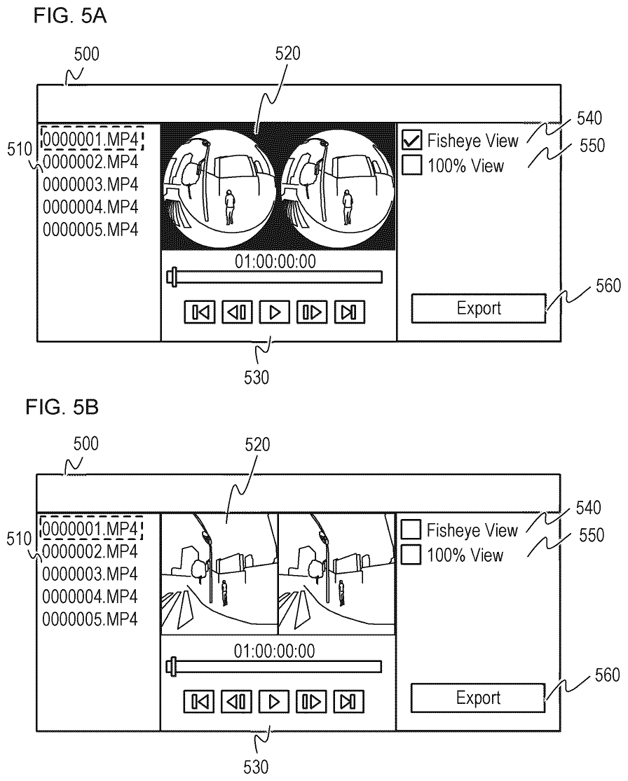

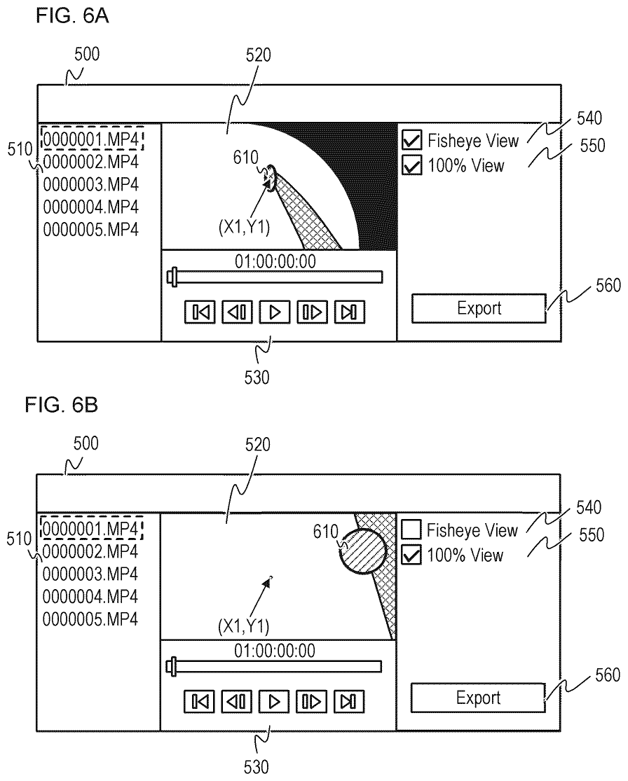

A process of displaying an “image based on a captured image of a real space” will be described with reference to FIG. 5A to FIG. 6B. Screen 500 (display application screen) is displayed in the display unit 406 by starting up a display application in the following process.

The screen 500 includes a clip selection region 510, an image display region 520, a playback control region 530, a check box 540, a check box 550, and an export button 560.

The clip selection region 510 lists up the video files read into the display application. The user selects a video file that s/he wishes to play back (check) from the list (plurality) of video files in the clip selection region 510. Each of the video files here is a video (moving image) file acquired by shooting with the camera 100.

The image display region 520 displays a given frame (one still image) of the video file selected in the clip selection region 510 in a style according to the display mode.

With the display application running, the display modes are switched between two or more modes in accordance with an operation by the user. The plural display modes include a “fisheye image screen-fit mode” that displays a dual-eye image including two circular fisheye images fitted in the screen as shown in FIG. 5A. The plural display modes include an “equirectangular projection image screen-fit mode” that displays a side-by-side image including two images obtained by applying a geometric transformation (process for reducing distortions) based on equirectangular projection to the two circular fisheye images (hereinafter called “equirectangular projection images”) fitted in the screen as shown in FIG. 5B. Here, the “screen-fit” means displaying an image in a reduced size so that the image fits into the image display region 520 in its entirety.

The plural display modes also include a “fisheye image zoom-in mode” that displays an area of the dual-eye image as shown in FIG. 6A, and an “equirectangular projection image zoom-in mode” that displays an area of the side-by-side image (equirectangular projection images) as shown in FIG. 6B. In the case where an area of an image is displayed, this area may be displayed dot by dot (at 100% magnification). “Dot by dot” here refers to a style of displaying an image without downsampling or compressing the image information, one screen pixel corresponding to one image pixel.

In Embodiment 1, the circular fisheye image and the equirectangular projection image are supposed to have an equal size. For example, if one circular fisheye image is 4096×4096 in size, one equirectangular projection image is also 4096×4096 in size. The dual-eye image as a whole is twice as large as one circular fisheye image (i.e., 8192×4096).

In the camera 100, the two circular fisheye images (left-eye image and right-eye image) are reversed left to right when recorded. Therefore, when a dual-eye image is displayed, the two circular fisheye images are reversed back, so that the left-eye image and right-eye image are shown in the correct arrangement, before appearing in the image display region 520.

The image display region 520 accepts drag actions by the user. In the state in which a portion of the image is being displayed (with a tick in the check box 550 to be described later), the user can specify a range (image range) to be displayed in the image display region 520 by a drag action.

The playback control region 530 allows various operations for controlling the playback of the video file selected in the clip selection region 510 (e.g., start playback, pause, fast-forward or rewind frame by frame, seek to any frame, etc.).

The check box 540 allows the user to select which of a circular fisheye image and an equirectangular projection image is to be displayed in the image display region 520 by ticking or not ticking the box.

The check box 550 allows the user to change the display style of the image by ticking or not ticking the box. Namely, the check box 550 allows the user to toggle between partial view and fit-to-screen view of the image in the image display region 520 by ticking or not ticking the box.

Specifically, if the check box 540 is ticked and the check box 550 is not ticked, the display mode is set to the “fisheye image screen-fit mode” shown in FIG. 5A. If the check box 540 is not ticked and the check box 550 is not ticked, the display mode is set to the “equirectangular projection image screen-fit mode” shown in FIG. 5B.

If the check box 540 is ticked and the check box 550 is ticked, the display mode is set to the “fisheye image zoom-in mode” shown in FIG. 6A. If the check box 540 is not ticked and the check box 550 is ticked, the display mode is set to the “equirectangular projection image zoom-in mode” shown in FIG. 6B. Hereinafter, the check box being ticked will be referred to simply as the “check box being ON.” The check box not being ticked will be referred to simply as the “check box being OFF.”

Pressing down the export button 560 causes an equirectangular projection image (image obtained by applying a transformation based on equirectangular projection to a circular fisheye image to reduce distortions) to be stored as another file.

In addition to the check box 550, another display item (such as a controller) for allowing the user to specify a given magnification may be shown in the screen 500. The image display region 520 may allow display of an even more magnified image than the dot-by-dot display (image with a higher display magnification).

FIG. 6A shows the screen after the user has already adjusted the display position of the dual-eye image so that an object 610 in the right-eye image is displayed (appears) in the center of the image display region 520. Let us assume that, relative to the origin (0, 0) that is the upper left corner of the entire dual-eye image (i.e., 8192×4096 image), the coordinates of the center of the object 610 are determined as coordinates (X1, Y1). If the user turns on the check box 540 under this condition without adjusting the display position of the side-by-side image (object 610), an area corresponding to the coordinates (X1, Y1) of the side-by-side image will be displayed in the center of the image display region 520. This will result in the object 610 being displayed (appearing) off the center of the image display region 520 as shown in FIG. 6B.

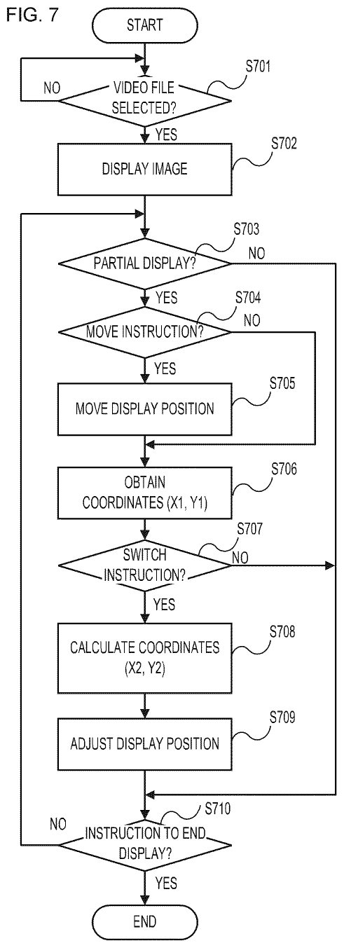

Next, the operation of the PC 400 according to Embodiment 1 will be described with reference to the flowchart of FIG. 7. The process in the flowchart of FIG. 7 can be implemented by the controller 401 executing a program.

At step S701, the controller 401 determines whether or not one of one or more video files stored in the external memory device 404 has been selected by the user. When it is determined that one video file has been selected, the process goes to step S702. When it is determined that no video file has been selected, step S701 is repeated.

At step S702, the controller 401 displays an image included in the video file selected at step S701 (hereinafter called “selected image”) in the image display region 520. At this time, the controller 401 displays the selected image entirely or partially in the image display region 520 in a display mode according to the state of the check box 540 and check box 550. In Embodiment 1, the selected image is either a dual-eye image or a side-by-side image.

At step S703, the controller 401 determines whether or not the check box 550 is ON (which indicates that a part of the image is being displayed). When it is determined that the check box 550 is ON, the process goes to step S704. When it is determined that the check box 550 is OFF, the process goes to step S710.

At step S704, the controller 401 determines whether or not there has been a drag action by the user instructing a move of the display position of the selected image. When it is determined a move instruction has performed, the process goes to step S705. When it is determined that no move instruction has performed, the process goes to step S706.

At step S705, the controller 401 moves the display position of the selected image in accordance with the move instruction (drag action by the user).

At step S706, the controller 401 obtains coordinates (X1, Y1) of the selected image corresponding to a center position of the image display region 520.

At step S707, the controller 401 determines whether or not the check box 540 has been toggled ON and OFF (i.e., the display modes have been switched between the “fisheye image zoom-in mode” and the “equirectangular projection image zoom-in mode”). When it is determined that the check box 540 has been toggled ON and OFF, the process goes to step S708. When it is determined that the check box 540 has not been toggled ON and OFF, the process goes to step S710.

At step S708, the controller 401 calculates coordinates (X2, Y2) of the selected image after the switching of the display modes corresponding to the coordinates (X1, Y1) of the selected image before the switching of the display modes. Here, the “selected image before the switching of the display modes” is the image displayed in the image display region 520 before the display mode was switched (either a dual-eye image or side-by-side image). The “selected image after the switching of the display modes” is the image displayed in the image display region 520 after the display mode was switched (either a dual-eye image or side-by-side image).

Coordinates (X2, Y2) in an equirectangular projection image corresponding to the coordinates (X1, Y1) in a circular fisheye image can be obtained, for example, by a known geometric transformation technique based on equirectangular projection. For calculating coordinates in a circular fisheye image corresponding to the coordinates in an equirectangular projection image, an inverse geometric transformation technique based on equirectangular projection can be used. A two-dimensional table of coordinates of circular fisheye images and equirectangular projection images matched with each other may be prepared in advance and stored in the RAM 403 or external memory device 404. This two-dimensional table may be looked up when calculating coordinates in response to switching of the display modes.

At step S709, the controller 401 adjusts (determines) the display position of the selected image after the switching of the display modes such that the coordinates (X2, Y2) calculated at step S708 are positioned at the center of the image display region 520. The controller 401 then displays the selected image in the style according to the display mode after the switching at the adjusted display position. This allows the user to toggle the display modes between the fisheye image zoom-in mode and the equirectangular projection image zoom-in mode, and to still see the object that the user was checking in the center of the image display region 520 before switching the display modes, in the center of the image display region 520, even after switching the display modes.

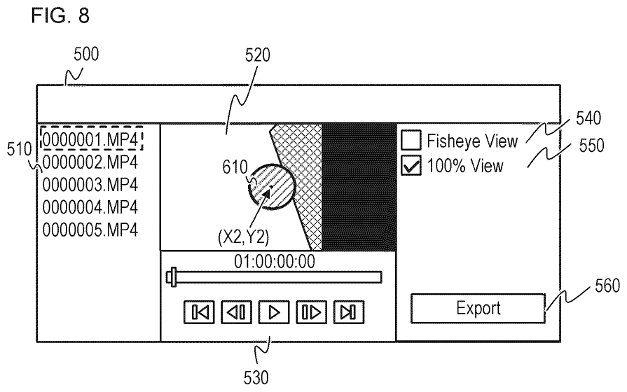

For example, the object 610 appearing in a center position of the image display region 520 in the fisheye image zoom-in mode as shown in FIG. 6A appears also in the center position of the image display region 520 even after the display mode is switched to the equirectangular projection image zoom-in mode, as shown in FIG. 8. This is because the display position of the side-by-side image is controlled (adjusted) such that the center coordinates (X2, Y2) of the object 610 in the side-by-side image will be located in the center position of the image display region 520.

In the case where the display position of the selected image in the display mode after the switching is not adjusted (if the step S709 is not carried out), the coordinates (X1, Y1) of the selected image in the display mode after the switching are placed at the center position of the image display region 520 (see FIG. 6B). Namely, the coordinates of one point in the image in the display mode before the switching, and the coordinates of the same point in the image in another display mode after the switching, will both be located in the center position of the image display region 520. This may cause different targets (objects) to appear in the center position of the image display region 520 before and after the switching of the display modes.

At step S710, the controller 401 determines whether or not an instruction to end the display (e.g., an operation to end the screen 500) has performed by the user. When it is determined that an instruction to end the display has performed, the process of the flowchart ends. When it is determined that no instruction to end the display has performed, the process returns to step S703.

According to Embodiment 1, when the display modes are switched between the fisheye image zoom-in mode and the equirectangular projection image zoom-in mode, an object (target) that was displayed in the center of the image display region 520 before the switching of the display modes can be displayed also in the center of the image display region 520 even after the switching of the display modes.

Embodiment 1 is applicable not only to when the display mode is switched from the fisheye image zoom-in mode to the equirectangular projection image zoom-in mode, but also to when the display mode is switched from the equirectangular projection image zoom-in mode to the fisheye image zoom-in mode.

### Embodiment 2

Embodiment 2 will be described with respect to a case where two image regions are contained in the image display region 520 in the fisheye image zoom-in mode and in the equirectangular projection image zoom-in mode. The imaging device (camera and lens unit) according to Embodiment 2 has the same configuration as that of the imaging device according to Embodiment 1, i.e., is adapted to record video files similar to those of Embodiment 1. The PC 400 according to Embodiment 2 has the same configuration as that of the PC 400 according to Embodiment 1.

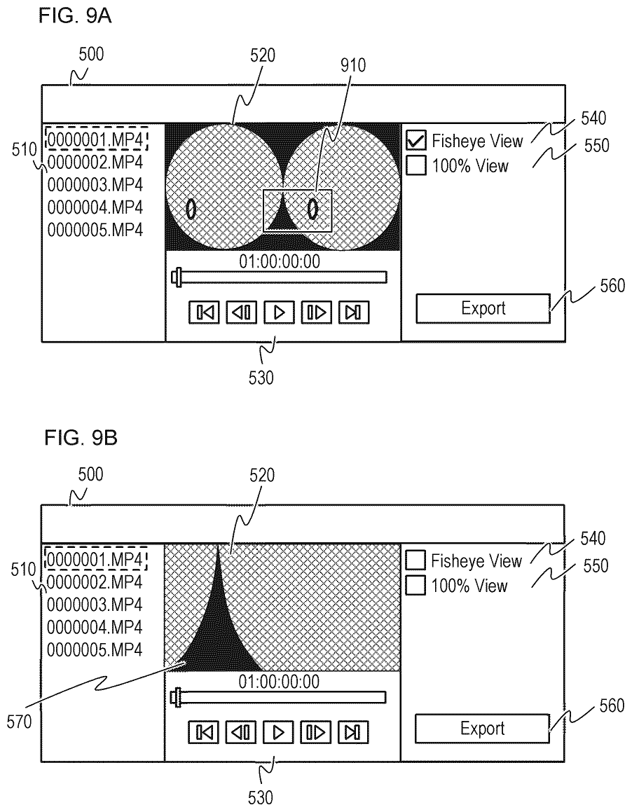

FIG. 9A shows a screen 500 in the fisheye image screen-fit mode. FIG. 9B shows a screen 500 in the fisheye image zoom-in mode.

Below, a region of the right-eye image (captured via the right-eye optical system 301R) in the dual-eye image, and a region of an image corresponding to the right-eye image of the side-by-side image (equirectangular projection image on the right side) will both be referred to as a “right-eye region.” Likewise, a region of the left-eye image (captured via the left-eye optical system 301L) in the dual-eye image, and a region of an image corresponding to the left-eye image of the side-by-side image (equirectangular projection image on the left side) will both be referred to as a “left-eye region.”

The image display region 520 in FIG. 9B shows an area inside of the frame 910 in FIG. 9A dot by dot. The frame 910 contains therein an object located close to the right end of the left-eye image, and an object located close to the left end of the right-eye image. These objects are hardly correlated to each other. In the state of FIG. 9B, the user is likely to pay more attention to the object of the right-eye image, which takes up a larger area in the image display region 520.

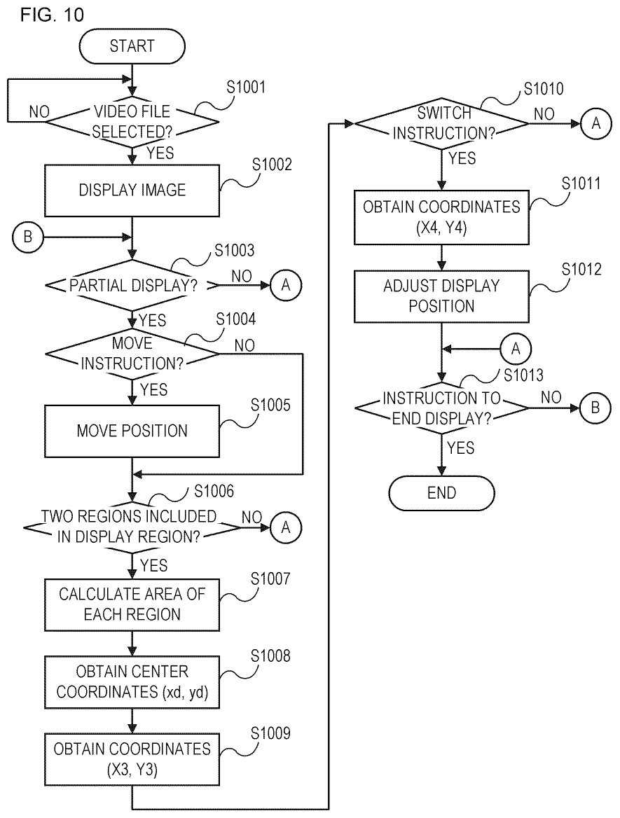

The operation of the PC 400 according to Embodiment 2 will be described with reference to the flowchart of FIG. 10. Steps S1001 and S1002 in FIG. 10 are the same as steps S701 and S702 of FIG. 7 in Embodiment 1, and therefore the description thereof will be omitted.

At step S1003, the PC 400 determines whether or not the check box 550 is ON (which indicates that a part of the image is being displayed). When it is determined that the check box 550 is ON, the process goes to step S1004. When it is determined that the check box 550 is not ON, the process goes to step S1013.

At step S1004, the controller 401 determines whether or not there has been a drag action by the user to the image display region 520, instructing a move of the display position of the selected image. When it is determined that an instruction to move the display position has performed, the process goes to step S1005. When it is determined that no instruction to move the display position has performed, the process goes to step S1006.

At step S1005, the controller 401 moves the display position of the selected image in accordance with the move instruction by the user (the amount of drag action).

At step S1006, the controller 401 determines whether or not the image display region 520 includes both of a left-eye region and a right-eye region. When it is determined that the image display region 520 includes both the left-eye region and right-eye region, the process goes to step S1007. When it is determined that the image display region 520 includes only one of the left-eye region and the right-eye region, the process goes to step S1013. In the case where the image display region 520 includes only one of the left-eye region and the right-eye region, the display position can be controlled by the process described in Embodiment 1 (steps S706 to S709).

At step S1007, the controller 401 calculates the area of the left-eye region in the image display region 520, and the area of the right-eye region in the image display region 520.

At step S1008, the controller 401 determines which of the left-eye region and the right-eye region has a larger area based on the calculation at step S1007 (determines a region with a maximum display area). The controller 401 obtains the coordinates (xd, yd) of the center position of the range of the region with the maximum display area displayed in the image display region 520. The coordinates (xd, yd) are the coordinates in the image display region 520.

At step S1009, the controller 401 obtains coordinates (X3, Y3) in the entire image displayed in the image display region 520 corresponding to the coordinates (xd, yd).

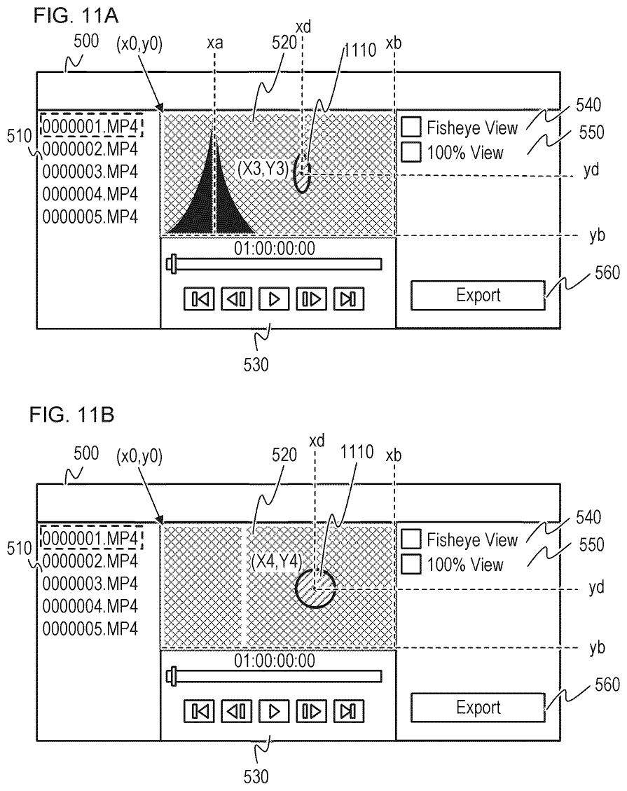

FIG. 11A is a diagram explaining step S1008 and step S1009 in more detail. FIG. 11A shows a screen 500 in the fisheye image zoom-in mode. Coordinates (x0, y0) in FIG. 11A represent the coordinates of the origin (0, 0) of the coordinate system of the image display region 520 (hereinafter, “display coordinate system”). X-coordinate xa represents the x-coordinate at the boundary between the left-eye image and the right-eye image in the display coordinate system. X-coordinate xb represents the maximum x-coordinate in the display coordinate system, and y-coordinate yb represents the maximum y-coordinate in the display coordinate system. The coordinates (xd, yd) can be calculated from the following equations:

$$x d = ( x a + xb ) / 2$$

$$y d = ( y 0 + yb ) / 2$$

FIG. 11A shows an object 1110 positioned at the coordinates (xd, yd) in the image display region 520. Accordingly, the controller 407 obtains the coordinates (X3, Y3) of the position of the object 1110 in the coordinate system of the entire dual-eye image including the left-eye image and right-eye image (image coordinate system).

At step S1010, the controller 401 determines whether or not an instruction to toggle On and Off of the check box 540 (i.e., instruction to toggle between the “fisheye image zoom-in mode” and the “equirectangular projection image zoom-in mode”) has performed. When it is determined that an instruction to toggle On and Off of the check box 540 has performed, the process goes to step S1011. When it is determined that no instruction to toggle On and Off of the check box 540 has performed, the process goes to step S1013.

At step S1011, the controller 401 calculates coordinates (X4, Y4) of the selected image after the switching of the display modes corresponding to the coordinates (X3, Y3) of the selected image before the switching of the display modes.

At step S1012, the controller 401 adjusts the display position of the selected image after the switching of the display modes so that the coordinates (X4, Y4) in the selected image after the switching of the display modes will be positioned at the coordinates (xd, yd) in the image display region 520. The controller 401 then displays the selected image after the switching of the display modes at the adjusted display position.

This allows the user to see the same object in the same position in the image display region 520, even when the display modes are switched between the fisheye image zoom-in mode and the equirectangular projection image zoom-in mode. Specifically, the user, who was checking an object in a center position of a range of the image display region 520 where one region (one of the two regions with a larger area) appears before switching the display modes, can still see the object at the same position in the image display region 520 after the switching of the display modes.

FIG. 11B shows a screen 500 after the display mode was switched to the equirectangular projection zoom-in mode from the state shown in FIG. 11A. FIG. 11B shows the object 1110 having coordinates (X4, Y4) of the entire side-by-side image positioned at the coordinates (xd, yd) in the image display region 520.

At step S1013, the controller 401 determines whether or not an instruction to end the display (e.g., an operation to end the screen 500) has performed by the user. When it is determined that an instruction to end the display has performed, the process of the flowchart ends. When it is determined that no instruction to end the display has performed, the process returns to step S1003.

In Embodiment 2, it is determined whether or not the image display region 520 contains both the left-eye region and the right-eye region of the image before the switching of the display modes between the fisheye image zoom-in mode and the equirectangular projection image zoom-in mode. If the left-eye region and right-eye region are both included in the image display region 520, the object positioned at the center of a range of the image display region 520 where one region appears before the switching is displayed at the same position in the image display region 520 after the switching.

In the case where the user does not move the display position at step S1005, the steps S1007 and S1008 need not be carried out, and the information of coordinates (xd, yd) that were obtained in the past may be used from the step S1009 onward. This way, the object can be displayed at a fixed position.

### Variation Example 1

While examples in the case with video files were described in the above embodiments, still image files in JPEG, TIFF, or other formats may also be used instead of video files.

In Embodiment 1, an object that was positioned in the center of the image display region 520 before the display modes are switched is displayed also in the center of the image display region 520 after the display modes were switched. The object can be displayed at any fixed position, not necessarily in the center but anywhere in the image display region 520. For example, the fixed position for the object in the image display region 520 can be specified by the user, by an operation of a mouse or on a touchscreen. Alternatively, the fixed position for the object in the image display region 520 may be the position of a specific item (object) detected by a known object detection or object recognition technique.

When more than a certain proportion of the image display region 520 is a region other than the circular fisheye image in the fisheye image zoom-in mode, the controller 401 may not adjust the display position as described in the above embodiments. This is because, when the display mode is switched to the equirectangular projection image zoom-in mode, the coordinates corresponding to some of the coordinates before the switching of the display modes may not be present in the equirectangular projection image. Alternatively, the controller 401 may display an alert message in such a case (e.g., a message prompting the user to move the display position of the image). Here, “a region other than the circular fisheye image” refers to a region other than “the region captured via the optical system.” “A region other than the circular fisheye image” is, for example, the black region 570 in FIG. 9 where there are no objects.

Another possible situation in the fisheye image zoom-in mode is where most (more than a certain proportion) of the dual-eye image is displayed in the image display region 520. This may arise, for example, when the screen 500 is displayed as large as possible in a high-resolution display device (such as 8K resolution display). In such a case, the position of the object is unlikely to change largely when the display modes are switched. Therefore, the controller 401 may not necessarily need to adjust the display position of the side-by-side image after the display modes are switched from the fisheye image zoom-in mode to the equirectangular projection image zoom-in mode.

According to the present invention, the strange feeling the user feels when switching from viewing a portion of an image to the portion of the image after distortions in that image are corrected, can be reduced.

While the present invention has been described in detail on the basis of the preferred embodiments, the present invention is not limited to these specific embodiments, and various other forms not departing from the scope of this invention are included in the present invention. Parts of various embodiments may be combined as suited.

The phrase “when A is B or more, the process goes to step S1, and when A is smaller (lower) than B, the process goes to step S2” may be interpreted as “when A is larger (higher) than B, the process goes to step S1, and when A is B or less, the process goes to step S2.” Conversely, the phrase “when A is larger (higher) than B, the process goes to step S1, and when A is B or less, the process goes to step S2” may be interpreted as “when A is B or more, the process goes to step S1, and when A is smaller (lower) than B, the process goes to step S2.” Namely, unless a contradiction arises, “A or more” can be interpreted as “larger (higher, longer, more) than A,” and “A or less” can be interpreted as “smaller (lower, shorter, less) than A.” Likewise, “larger (higher, longer, more) than A” can be interpreted as “A or more”, and “smaller (lower, shorter, less) than A” can be interpreted as “A or less.”

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-119045, filed on Jul. 21, 2023, which is hereby incorporated by reference herein in its entirety.

What is claimed is:

1. An electronic device comprising:
a processor; and
a memory storing a program which, when executed by the processor, causes the electronic device
to perform an acquisition process of acquiring a first image, and a second image that is an image obtained by applying a geometric transformation to the first image to reduce distortion,
to perform a switching process of switching display modes between a first mode of displaying an area of the first image in a display region, and a second mode of displaying an area of the second image in the display region, and,
in a case where the display modes are switched, to perform an adjustment process of adjusting a display position of an image that is displayed in the display region after the switching of the display modes such that an object located in a first position in the display region before the switching of the display modes will be located in the first position after the switching of the display modes.

2. The electronic device according to claim 1, wherein,
in the case where the display modes are switched, the adjustment process includes
obtaining a first coordinate that is a coordinate of the object in an image displayed in the display region before the switching of the display modes,
obtaining a second coordinate that is a coordinate of the object in the image that is displayed in the display region after the switching of the display modes, based on the first coordinate, and
adjusting the display position of the image that is displayed in the display region after the switching of the display modes such that the second coordinate is placed at the first position.

3. The electronic device according to claim 1, wherein
the first image is displayed dot by dot in the first mode, and
the second image is displayed dot by dot in the second mode.

4. The electronic device according to claim 1, wherein
the first position is a center position of the display region.

5. The electronic device according to claim 1, wherein
the first position is a position specified by a user.

6. The electronic device according to claim 1, wherein
the first position is a position where a specific object is located before the switching of the display modes.

7. The electronic device according to claim 1, wherein
the first image includes a first region acquired by imaging via a first optical system, and a second region acquired by imaging via a second optical system, and
the second image includes a third region that is a region obtained by the geometric transformation applied to the first region, and a fourth region that is a region obtained by the geometric transformation applied to the second region.

8. The electronic device according to claim 7, wherein,
in a case where the first mode is switched to the second mode, and where a range where the first region appear in the display region is larger than a range where the second region appear in the display region, the first position is a center position of the range where the first region appear in the display region.

9. The electronic device according to claim 7, wherein,
in a case where the first mode is switched to the second mode, and where more than a certain proportion of the display region before the switching of the display modes is a region other than the first region and the second region, the display position of the image that is displayed in the display region after the switching of the display modes is not adjusted in the adjustment process.

10. The electronic device according to claim 1, wherein,
in a case where a range of an image displayed in the display region before the switching of the display modes is larger than a certain proportion of the entire image containing the range, the display position of the image that is displayed in the display region after the switching of the display modes is not adjusted in the adjustment process.

11. The electronic device according to claim 1, wherein,
in a case where the display position of the image that is displayed in the display region after the switching of the display modes is not adjusted, a third coordinate in the image that is displayed in the display region after the switching of the display modes is placed at the first position, in the adjustment process, the third coordinate being a coordinate of the object in an image displayed in the display region before the switching of the display modes.

12. A method of controlling an electronic device, comprising:
an acquisition step of acquiring a first image, and a second image that is an image obtained by applying a geometric transformation to the first image to reduce distortion;
a switching step of switching display modes between a first mode of displaying an area of the first image in a display region, and a second mode of displaying an area of the second image in the display region; and,
in a case where the display modes are switched, an adjustment step of adjusting a display position of an image that is displayed in the display region after the switching of the display modes such that an object located in a first position in the display region before the switching of the display modes will be located in the first position after the switching of the display modes.

13. A non-transitory computer readable medium that stores a program, wherein the program causes a computer to execute a method of controlling an electronic device,
the method of controlling the electronic device comprising:
an acquisition step of acquiring a first image, and a second image that is an image obtained by applying a geometric transformation to the first image to reduce distortion;
a switching step of switching display modes between a first mode of displaying an area of the first image in a display region, and a second mode of displaying an area of the second image in the display region; and,
in a case where the display modes are switched, an adjustment step of adjusting a display position of an image that is displayed in the display region after the switching of the display modes such that an object located in a first position in the display region before the switching of the display modes will be located in the first position after the switching of the display modes.
